(19) United States
(12) Patent Application Publication
(10) Pub. No.: US 2026/0076384 A1
(43) Pub. Date: Mar. 19, 2026

(54) COMPOSITION AND METHOD OF MAKING A GEL SYSTEM FOR VEGAN MEAT ANALOGS

(71) Applicant: KELLANOVA, Battle Creek, MI (US)

(72) Inventors: Monjur HOSSEN, Kalamazoo, MI (US); Ebenezer IFEDUBA, Battle Creek, MI (US)

(21) Appl. No.: 19/107,344

(22) PCT Filed: Aug. 31, 2023
(86) PCT No.: PCT/US2023/031690

§ 371 Date: Feb. 27, 2025

Related U.S. Application Data
(60) Provisional application No. 63/402,745, filed on Aug. 31, 2022.

(51) Int. Cl. A23D 7/005; A23D 7/04; A23J 3/14; A23J 3/16; A23J 3/18; A23J 3/22; A23L 29/262

(52) U.S. Cl. CPC A23D 7/0053; A23D 7/04; A23J 3/14; A23J 3/16; A23J 3/18; A23J 3/227; A23L 29/262

(57) ABSTRACT

A gel system formulation and method for making thereof that includes a hard fat, liquid fat, and methyl cellulose, which when incorporated into vegan meat alternative formulations more closely resembles meat-based counterparts in appearance, taste, texture, and quality.

### CROSS REFERENCE TO RELATED APPLICATIONS

This application claims the benefit of U.S. Provisional Application Ser. No. 63/402,745, filed Aug. 31, 2022. The disclosure of which is hereby incorporated by reference in its entirety.

### TECHNICAL FIELD

This disclosure relates to compositions and methods of producing a plant-based, meat analog including a novel gel system composition.

### BACKGROUND

Consumer interest in plant-based foods continues to gain interest as people attempt to choose snacks and meals that are healthier and better for both themselves and the environment. The shift to plant-based eating can present a big shift in lifestyle for consumers and meeting this demand depends on the plant-based alternatives tending to closely mimic the meat products they are replacing. Many consumers are unwilling to sacrifice their eating experience when eating plant based foods. Consumers tend to demand that these plant based foods closely resemble their respective meat analog in terms of taste, texture, and visual appearance. The current plant based meat analogs available on the market fall short in simulating the texture, firmness, and moisture of real meat at room temperature.

### SUMMARY

The current formulations of meat analogs, in some circumstances, have an undesirable texture and firmness at room temperature. The incorporation of a new thermo-gel system formulation disclosed herein into vegan meat analog compositions improves the product firmness and texture at room temperature, making the product resemble the texture of animal meat products at both hot and room temperatures.

In some embodiments, the gel system formulation comprises about 58 to about 79 weight percent water, about 1 to about 18 weight percent methyl cellulose, about 5 to about 26 weight percent liquid oil, and about 5 to about 25 percent hard fat. In some aspects, the gel system formulation comprises, consists essentially of, or consists of about 68.8 weight percent water, about 6.5 weight percent methyl cellulose, about 15.8 weight percent liquid oil, and 9.0 weight percent hard fat. In some aspects, the liquid oil in the gel system is a vegetable oil comprising canola, coconut, cottonseed, soybean, sunflower, safflower, palm oil, or grape seed oil, or combination thereof. In some aspects, the hard fat in the gel system is a fully saturated vegetable oil. In some aspects, the hard fat in the gel system is a fully hydrogenated canola, coconut, cottonseed, soybean, sunflower, safflower, palm oil, or grape seed oil, or combination thereof.

In other embodiments, the method of making the new gel system formulation includes the following steps: (1) dispersing methyl cellulose in liquid oil in a high shear mixer; (2) adding chilled water at temperature of about 35 to about 45° F. to the mixture of methyl cellulose and liquid oil; (3) mixing until a marshmallow-like consistency is formed; and (4) mixing in the hard fat. In other embodiments, the methods of making plant-based meat analogs to better simulate the texture and firmness of a processed or unprocessed animal meat at hot and room temperatures involves introducing the new gel system formulations disclosed herein with other ingredients of a vegan meat alternative.

In some embodiments, the gel system is incorporated into vegetarian meat analog compositions, such as vegan burgers and sausage links.

The details of one or more implementations of the disclosure are set forth in the accompanying FIGURE and the description below. Other aspects, features, and advantages will be apparent from the description, drawing, and the claims.

### DESCRIPTION OF DRAWINGS

The drawing described herein is for illustrative purposes only of a selected configuration and not all possible implementations, and is not intended to limit the scope of the present disclosure.

FIG. 1 shows a graph depicting the gel firmness (as measured by the force (g) required for depression) of gel system formulations with different proportions of oil and solid fat (100% oil/0% fat; 75% oil/25% fat; 50% oil/50% fat; and 25% oil/75% fat) and methyl cellulose (6% or 7%) at room temperature (70° F.) and heated temperature (160° F.).

### DETAILED DESCRIPTION

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The term “hard fat” used herein describes a fully hydrogenated vegetable oil. A fully hydrogenated vegetable oil, also known as fully saturated, has all carbon-carbon double bonds reduced. The hydrogenation process turns the fat into a solid at room temperature; hence the terminology “hard fat”. In some embodiments, the fully hydrogenated vegetable fat may be a C8-C12 fatty acid.

The term “liquid oil” includes any vegetable fat that is liquid at room temperature (70° F.). The substitution of meat proteins with vegetables and other non-meat proteins by consumers can be motivated by the consumer's decision to improve their health and wellness, in addition to being more sustainable for the environment. Consumer acceptance of meat-like products formulated from plant or vegetable based proteins is in a large part predicated on the appearance, texture, taste, and bite/chewiness as compared to similar meat products. The duplication of these organoleptic properties to match those found in natural meat products is difficult both in terms of compositions and processing.

The current plant based meat analogs begin to lose their firmness at room temperature, resulting in a squishy texture that is not appealing to the consumer. In other embodiments, the gel systems herein may be used in about 15 to about 35 weight percent of vegan meat alternatives and can aid in defining the texture and firmness of the product at both elevated and room temperatures. The new gel systems herein improve the texture, firmness, moisture/fluid retention, and/or low synersis (separation of liquid from a gel) at both elevated and at room temperatures to deliver the desired consumer experience with respect to preferred organoleptic properties.

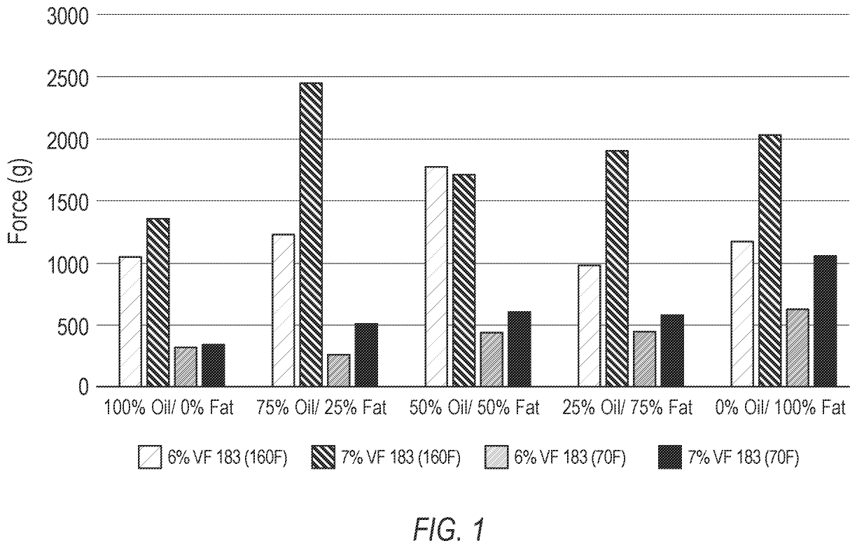

To improve the gel system in current vegetable based meat analogs, a hard fat was introduced into the gel system composition and the portions of hard fat to liquid oil varied to identify the proportions with optimal properties, see formulations tested in table 1 of Example 1. The concentration of methyl cellulose was also varied to identify the percent by weight that would produce optimal firmness with different portions of hard fat. The firmness of the different formulations at room temperatures (70° F.) and heated temperature (160° F.), as measured by shear modulus (g), are shown in FIG. 1. In some embodiments, a typical gel system formulation producing the desired properties is shown in Table 2 below.

The new gel system includes at least one type of hard fat in the formulation and may be combinations of hard fat. The hard fat is a fully hydrogenated vegetable oil. In some aspects, the hard fat is a fully hydrogenated corn, canola, coconut, cottonseed, soybean, sunflower, safflower, palm, palm kernel, or grape seed oil, or combination thereof. In one embodiment, the hard fat is added from about 5 to about 25 weight percent of the gel system (in other embodiments, about 5 to about 15 weight percent, about 5 to about 10 weight percent, or about 6 to about 10 weight percent). In some embodiments, the hard fat in the gel system is about 9.0 weight percent. The new gel system includes at least one type of liquid vegetable oil and may be combinations of liquid oils. In some aspects, the liquid vegetable oil is corn, canola, coconut, cottonseed, soybean, sunflower, safflower, palm, palm kernel, or grape seed oil, or combination thereof. The liquid oil is added from about 5 to about 26 weight percent of the gel system (in other embodiments, about 10 to about 20 weight percent, about 12 to about 18 weight percent, or about 12 to about 15 weight percent). The gel system includes methyl cellulose from about 1 to about 18 weight percent (in other embodiments, about 2 to about 15 weight percent, about 4 to about 10 weight percent, or about 5 to about 8 weight percent). In some embodiments, methyl cellulose in the gel system is from about 6 to about 7 weight percent. In some aspects, methyl cellulose in the gel system is 6.45% weight percent. The new gel system includes water (preferably chilled as discussed herein) from about 58 to about 79% weight percent (in other embodiments, about 60 to about 75 weight percent, about 62 to about 70 weight percent, or about 64 to about 70 weight percent). In some embodiments, the gel system has a ratio of liquid oil to hard fat of about 3:1 to about 1:3 or, in other approaches, about 2:1 to about 1:2.

In some embodiments, water in the gel system is about 68.8 weight percent. In some embodiments, the liquid vegetable oil in the gel system is about 15.8 weight percent. In some aspects, methyl cellulose in the gel system is about 6.5 weight percent. In some aspects, the liquid vegetable oil in the gel system is about 15.81% weight percent. In some aspects, the hard fat percent in the gel system is 8.97 weight percent.

In some embodiments, the method of making the gel system begins with dispersing the methyl cellulose in liquid oil using a high shear mixer. Methyl cellulose is a hydrocolloid gelling agent with hydrophilic colloid particles that have a thermoreversible property causing it to melt upon heating. Thus, dispersing methyl cellulose requires mixing in a high shear mixer with oil or heating to high temperatures. Chilled water of about 35 to about 45° F. is then added to the methyl cellulose and oil mixture and mixed until a marshmallow-like consistency is formed. The hard fat(s) is then mixed in to complete the gel system production.

In some embodiments, the gel system is made by adding liquid canola oil to a mixer at 15.8% of the final gel system by weight. The methyl cellulose is then slowly dispersed into the oil using a high shear mixer with the blade speed set at about 200 RPM and the bowl set to about 3 RPM until the methyl cellulose weight reaches 6.45% of the final gel system. Next, the methyl cellulose and oil is mixed for one minute with a blade speed 500 RPM and the bowl set to a speed of 14 RPM. Chilled water at a temperature of about 35 to about 45° F. is added to the mixing bowl and the ingredients mixed for two minutes with a blade speed of 2000 RPM, forming a marshmallow like consistency. Next, palm fat flakes (hard fat) is added to the mixture to the percent weight of 8.968% and mixed for three minutes.

The gel system was tested in three different vegan meat analog formulations, including a burger (Example 2), a tomato-basil burger (Example 3), and a sausage (Example 4). The disclosure describes a gel system formulation and methods for making the gel system, with the unique addition of a hard fat into the traditional gel system with an optimal methyl cellulose concentration, liquid oil, and water that creates a unique oleo gel with water release leading to succulent juicy bite and optimum level of firmness even after the product cools.

### EXAMPLES

The following examples are illustrative, and are not meant to be limiting, of the methods and compositions of the present disclosure. Other suitable modifications and adaptations of the variety of conditions and parameters normally encountered in the field, and which are obvious to those skilled in the art, are within the spirit and scope of the disclosure. Unless specified otherwise in this disclosure, all percentages, ratios, or amounts in the following examples and elsewhere in this disclosure are percent by weight.

### Example 1

This example provides a method of making an improved gel system. Different gel system formulations were tested to identify the effect of varying the percent of hard fat to liquid oil and percent methyl cellulose by weight, see formulations tested in Table 1.

### Methods

Each composition was made by first slowly dispersing the methyl cellulose (VF) into the liquid oil using a high shear mixer (chopper) with the blade set to a speed of about 200 RPM and the bowl to about 3 RPM. The methyl cellulose and oil were mixed for one minute with the blade set to about 500 RPM and the bowl set to about 14 RPM. Next, chilled water at a temperature of about 35 to about 45° F. was added to the mixing bowl and the ingredients mixed for two minutes at a blade speed setting of about 2000 RPM. The contents formed a marshmallow-like consistency. The firmness of each formulation was measured by the force (g) required for deformation. The results of the force (g) measurements are depicted in FIG. 1.

TABLE 1
Variation in percent methyl cellulose, liquid oil, and hard fat tested

| Methyl cellulose | | |
|---|---|---|
| (VF) % | Temperature 160° F. | Temperature 70° F. |
| 6% and 7% | 100% oil/ 0% hard fat | 100% oil/ 0% hard fat |
| 6% and 7% | 75% oil/ 25% hard fat | 75% oil/ 25% hard fat |
| 6% and 7% | 50% oil/ 50% hard fat | 50% oil/ 50% hard fat |
| 6% and 7% | 25% oil/ 75% hard fat | 25% oil/ 75% hard fat |
| 6% and 7% | 0% oil/ 100% hard fat | 0% oil/ 100% hard fat |

### Results

The graph in FIG. 1 shows the deformation force (g) required for different formulations at room temperature (70° F.) and at a heated temperature (160° F.). The X-axis shows force (g), which is also known as shear modulus. The shear modulus is determined by measuring deformation of the gel from applying a force parallel to one surface of a solid, while an opposing force acts its opposite surface and holds the solid in place. The higher the shear modulus the more force is required for deformation. The graph in FIG. 1 shows that the gel firmness of oil based and predominantly oil based formulations are significantly reduced at room temperature (70° F.) compared to the heated temperature (160° F.). However, increasing the percent of hard fat in exchange for liquid oil and also increasing the percent methyl cellulose from 6% to 7% increases the gel firmness as measured by force (g) at room temperature.

Table 2 shows a typical recipe for a unique gel system with improved texture and firmness at room temperature over previous formulations with no hard fat and lower percent methyl cellulose.

TABLE 2
Typical Gel system formulation; percent by weight of gel system

| Ingredient | Preferred | Suitable |
|---|---|---|
| Water | 68.8% | 58 to 79% |
| Methyl cellulose | 6.5% | 1 to 18% |
| Liquid Oil | 15.8% | 5 to 26% |
| Hard Fat | 9.0% | 5 to 26% |

### Example 2

This example tests the result of incorporating the gel system developed in Example 1 into a burger analog formulation also combined with an oil paste formulation. The gel system and an oil paste formulation for use in the burger analog of this Example is provided in Tables 3 and 4, respectively. The addition of oil paste to the formulation enhances the visual appearance of the burger.

### Methods

The gel system was made as described in Example 1 with the exception of using the oil and hard fat types as shown in Table 3.

TABLE 3
Gel system formulation for burger analog

| Ingredient | Amount |
|---|---|
| Canola oil | 15.8% |
| Methyl cellulose | 6.5% |
| Water (35-40° F.) | 68.8% |
| Palm fat flakes | 9.0% |

The oil paste of Table 4 below was made by adding the lecithin and the pea protein to the canola oil while a chopper was running at a blade speed of about 200 RPM and a bowl set to about 5 RPM. The bowl contents were then mixed for one minute with the blade speed of about 500 RPM and the bowl speed at about 9 RPM. With the chopper running, the palm fat was then added and mixed for an additional 30 seconds.

TABLE 4
Exemplary Oil paste formulation for an burger analog

| Ingredient | Amount |
|---|---|
| Canola oil | 23.9% |
| Lecithin | 1.1% |
| Pea protein concentrate | 2.7% |
| Water (35-40° F.) | 59.3% |
| Palm fat (flakes) | 13.1% |

An exemplary burger analog formulation including the gel system (Table 3) and oil paste (Table 4) is listed in Table 5 below. The formulation produces a ground-meat style vegan meat analog that may be shaped to form a burger patty. The method of making the meat analog begins with mixing a first textured soy protein with the first aliquot of water (40° F.) for about 10 minutes. Next, the flavors, colors, and other additive were added to a second aliquot of water and mixed. The water and additive mixture was then combined with the first textured soy protein and water mixture. The second textured soy protein was then added and mixed for about 10 minutes. The potato starch and pea protein were then added to this mixture and mixed for about two minutes. Next, the fat slurry was added to the mixture, mixed for about 2 minutes, and then cooled from about 45 to about 50° F.

The gel system of Table 3 was then mixed into the cooled mixture and mixed for about 8 minutes. Thereafter, the soy protein isolate (SPI slurry) was added and mixed for about 3 minutes. Finally, in the last step, the oil paste of Table 4 was incorporated into the burger mixture by mixing for about 1 minute.

TABLE 5
Burger formulation

| Ingredient | Amount |
|---|---|
| First textured soy protein granules | 12.9% |
| Total water | 30.7% |
| Flavors, colors, and other additives | 3.7% |
| Second textured soy protein flakes | 8.7% |
| Potato starch | 0.5% |
| Pea protein concentrate | 0.5% |
| Fat slurry (mixture of liquid oil and flavor) | 2.8% |
| Oil gel system (Table 3) | 15.4% |
| Soy protein isolate (SPI slurry - 40% solids and 21% protein) | 6.2% |
| Oil paste (Table 4) | 18.6% |

### Result:

Including the new gel system, optionally in the presence of the oil paste formulation, in the burger analog formulation produced the ideal level of firmness and juiciness at lower temperatures for an improved eating experience that rivaled that of a ground beef burger.

### Example 3

This example tests the expected result of incorporating the new gel system developed in Example 1 in a tomato-basil flavored burger formulation.

### Methods

The method for making the gel system and formulation for use in the tomato basil pizza burger formulation is as described in Example 1 and Table 3, respectively. The ingredient list for the tomato basil pizza burger is shown in Table 6.

TABLE 6
Expected Tomato basil burger formulation

| Ingredients | Amount |
|---|---|
| Texture soy protein concentrate | 13.0% |
| Tomato flakes | 1.9% |
| Water | 19.8% |
| Gluten | 3.6% |
| Ultra Fiber | 3.5% |
| Vegan cheese | 6.2% |
| Soy protein isolate | 2.9% |
| Gel system (Table 3) | 6.8% |
| Vegetable pieces (e.g., mushroom, onion, etc.) | 20.9% |
| Flavors, colors, and other additives | 8.9% |
| Quick rolled oats | 3.7% |
| Tomato paste | 7.1% |
| Methyl cellulose | 0.5% |
| Corn oil | 1.2% |

An expected method of making the tomato basil burger with the new gel system is described as follows: the texture soy protein concentrate, tomato flakes, and a portion of the water was mixed together at low speed and let rest for a minimum of about 20 minutes. The gluten, ultra-fiber (textured protein with soy protein and gluten), soy protein isolate, and vegan cheese was added to the rested mixture and mixed for about 4 minutes on high speed. Next, the improved gel system was added to the mixture and mixed on low speed for about 2 minutes. The tomato paste and a portion of the other flavors were added to the mixture and mixed for about 3 minutes. Then, the methyl cellulose and the flavor portion of the composition were added to the mixture and mixed on low for about 3 minutes. A second addition of water was added and mixed for about 1 minute on low speed, followed by the addition of corn oil and a final mixing at low speed for about 1 minute.

### Result

Including the new gel system in the tomato basil burger formulation is expected to produce the optimum level of firmness and juiciness at lower temperatures for an improved eating experience that rivals that of a ground beef burger.

### Example 4

This example tests the expected result of incorporating the new gel system described in Example 1 in a vegan-style sausage formulation.

### Methods

The gel system was made as described in Example 1 with the exception of using canola and palm fat flakes as shown in Table 3. A proposed ingredient list for the vegan-style sausage formulation is shown in Table 7.

An expected method of making the vegetable-based sausage analog is as follows: mixing the textured vegetable protein, the textured soy protein, and a portion of the water for about 10 minutes. Ground gluten was added to the mixture and mixed for about 3 minutes; more water was then added and mixed for an additional about 2 minutes. Next, vital wheat gluten was added and mixed for about 3 minutes. Potato starch was added and mixed for about 2 minutes. The flavors and other additives were mixed into water and then added into the mix and mixed for about 3 minutes. Soy isolate was then added and mixed for about 3 minutes. Canola and lecithin were mixed together and then added to the mixture by mixing for about 3 minutes. The mixture was cooled and then mixed until reaching a temperature of about 25° F. The gel system was next added to the mixture and mixed for about 5 minutes. Any remaining ingredients were mixed for about 3 minutes, including palm oil flakes, flavors, and sodium bicarbonate. The vegan sausage product may be formed into a patty or link.

TABLE 7
Expected Sausage formulation

| Ingredients | Amount |
|---|---|
| Textured vegetable protein | 2.8% |
| Water | 27.3% |
| First textured soy protein | 5.7% |
| Gluten | 6.5% |
| Vital wheat gluten | 3.3% |
| Potato starch | 1.3% |
| Flavors, colors, and other additives | 7.8% |
| Soy Isolate | 4.4% |
| Canola oil | 2.6% |
| Lecithin | 0.2% |
| Oil gel system (Table 3) | 34.8% |
| Palm oil flakes | 3.1% |
| Sodium biocarbonate | 0.3% |

### Result

Including the new gel system in a vegetable-based sausage analog is expected to produce the optimum level of firmness and juiciness at lower temperatures for an improved sausage eating experience that rivals that of a pork sausage link or patty.

A number of formulations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A gel system used in a meat analog composition that reproduces the firmness and texture of cooked animal meat product at room temperature, comprising the gel system as formulated by weight:
about 58 to about 79% water;
about 1 to about 18% methyl cellulose;
about 5 to about 26% liquid oil; and
about 5 to about 25% hard fat.

2. The gel system of claim 1, wherein the formulation consists essentially of:
about 68.8 weight percent water;
about 6.5 weight percent methyl cellulose;
about 15.8 weight percent liquid oil; and
about 9.0 weight percent hard fat.

3. The gel system of any one of claims 1 to 2, wherein the liquid oil is a vegetable oil.

4. The gel system of any one of claims 1 to 3, wherein the liquid oil is corn, canola, coconut, cottonseed, soybean, sunflower, safflower, palm, palm kernel, or grape seed oil, or combination thereof.

5. The gel system of any one of claims 1 to 4, wherein the hard fat is a fully hydrogenated vegetable oil.

6. The gel system of claim 5, wherein the fully hydrogenated vegetable oil is corn, canola, coconut, cottonseed, soybean, sunflower, safflower, palm, palm kernel, or grape seed oil, or combination thereof.

7. The gel system of any preceding claim, wherein the gel system has a ratio of liquid fat to hard fat of about 3:1 to about 1:3.

8. A method for making a gel system of any one of claims 1 to 7 for use in a meat analog composition, the method comprising;
dispersing methyl cellulose in the liquid oil in a high shear mixer;
adding water at temperature of about 35 to about 45° F. to the mixture of the methyl cellulose and the liquid oil;
mixing until a marshmallow-like consistency is formed; and
mixing in the hard fat.

9. The method of claim 8, wherein the gel system formulation comprises the following ingredients formulated by weight:
about 58 to about 79% water;
about 1 to about 18% methyl cellulose;
about 5 to about 26% liquid oil; and
about 5 to about 25% hard fat.

10. The method of claim 8, wherein the ingredients of the gel system formulation consists essentially of:
about 68.8 weight percent water;
about 6.5 weight percent methyl cellulose;
about 15.8 weight percent liquid oil; and
about 9.0 weight percent hard fat.

11. The method any one of claims 8-10, wherein the liquid oil is a vegetable oil.

12. The method of claim 11, wherein the liquid oil is corn, canola, coconut, cottonseed, soybean, sunflower, safflower, palm, palm kernel, or grape seed oil, or combination thereof.

13. The method of any one of claims 8-12, wherein the hard fat is fully hydrogenated vegetable oil.

14. The method of claim 13, wherein the hard fat is corn, canola, coconut, cottonseed, soybean, sunflower, safflower, palm, palm kernel, or grape seed oil, or combination thereof.

15. The method of any one of claims 8-14, wherein the gel system has a ratio of liquid fat to hard fat of about 3:1 to about 1:3.

15. A meat-analog composition suitable for a burger, the meat analog composition comprising:
about 10 to about 15 weight percent of a first textured soy protein;
about 25 to about 25 weight percent of water;
about 2 to about 10 weight percent of a second textured soy protein;
about 10 to about 20 weight percent of the gel system of any one of claims 1 to 7; and
optionally, about 10 to about 20 weight percent of an oil paste including one or more vegetable oils, one or more hard fats, lecithin, pea protein, and water.

16. A flavored meat-analog composition suitable for a burger, the flavored meat analog composition comprising:
about 10 to about 20 weight percent of a textured soy protein concentrate;
about 10 to about 25 weight percent water;
about 1 to about 5 weight percent of soy protein isolate;
about 5 to about 12 weight percent of one or more vegetables;
about 1 to about 10 weight percent of the gel system of any one of claims 1 to 7;
about 0.1 to about 1 weight percent of methyl cellulose; and
about 0.5 to about 2 weight percent of liquid vegetable oil.

17. A meat-analog composition suitable for a sausage-analog composition, the meat-analog composition comprising:
about 1 to about 5 weight percent of a textured vegetable protein;
about 20 to about 30 weight percent water;
about 2 to about 8 weight percent of a textured soy protein;
about 4 to about 8 weight percent of gluten
about 1 to about 4 weight percent of vital wheat gluten
about 0.5 to about 2 weight percent of potato starch
about 2 to about 8 weight percent of soy isolate;
about 1 to about 4 weight percent of a vegetable oil;
about 0.1 to about 1 weight percent of lecithin;
about 25 to about 40 weight percent of the oil gel system of any one of claims 1 to 7;
about 1 to about 5 weight percent of palm flakes; and
about 0.1 to about 0.5 weight percent of sodium bicarbonate.
